(19) United States
(12) Patent Application Publication
(10) Pub. No.: US 2005/0083190 A1
(43) Pub. Date: Apr. 21, 2005

(54) Apparatus for warning of child left in vehicle

(76) Inventor: David L. James, Tulsa, OK (US)

Correspondence Address: ROSSI & ASSOCIATES, P.O. BOX 826, ASHBURN, VA, 20146-0826, US

(21) Appl. No.: 10/687,339

(22) Filed: Oct. 18, 2003

(51) Int. Cl. B60Q 1/00

(52) U.S. Cl. 340/457; 340/425.5

(57) ABSTRACT

A child safety warning device alerts a driver of the presence of a child within the vehicle after the driver has turned off the vehicle ignition. The child safety warning device is compact and can be easily transported between vehicles. Further, the simple design of the child safety warning device enables the device to be produced at a relatively low cost when compared with other child safety warning devices. Specifically, the child safety warning device includes a portable housing, a recording device located within the housing, a connector coupled to the housing and adapted to fit within a vehicle socket, and a switching device coupled to the recording device and the connector. The switching device provides a signal to the recording device indicative of an ignition state of a vehicle. The recording device plays back a prerecorded message in response to the signal provided by the switching device to warn the vehicle driver of the presence of a child within the vehicle when the ignition is turned off.

### FIELD OF THE INVENTION

This invention relates in general to child safety warning devices. In particular, the invention relates to a child safety warning device that reminds a vehicle driver of the presence of a child within a vehicle.

### BACKGROUND OF THE INVENTION

Each year media reports cover the tragic and unnecessary deaths of young children who are left unattended in automobiles after the driver has turned of the ignition and exited the vehicle. Most instances involve a child that is quietly asleep in a rear seat and a driver that leaves the vehicle forgetting that the child remains constrained in a safety seat within the automobile. The majority of fatalities occur during the summer and winter seasons when outside temperatures can be extremely hot or cold. In summer, the temperature within a closed vehicle can well exceed the external ambient temperature. Infants exposed to high temperatures can become dehydrated and slip into a comatose state unable to move, cry or otherwise attract attention.

Child detection systems have been proposed to detect and warn of the presence of a child left within a vehicle. U.S. Pat. No. 5,793,291, for example, discloses a device that utilizes a motion detector to detect the presence of a child left in a vehicle. This type of device will fail to generate a warning signal, however, if the child is asleep or stays relatively still within the vehicle. Other proposed systems overcome this problem by detecting the actual presence of a child within a seat. U.S. Pat. No. 5,949,340, for example, discloses a device that detects the presence of a child in a safety seat and emit a warning signal if the child remains in the seat after the vehicle ignition is turned off. Although this type of device will detect the presence of a child that is quietly sleeping in a vehicle, it necessitates the integration of the safety seat with the ignition and electrical system of the vehicle via an electrical connection, thus requiring some degree of compatibility between the safety seat and the particular vehicle in which it is to be placed.

In view of the above, it would be desirable to provide a child safety warning device that will alert a driver of the presence of a child within the vehicle that is simple in design and inexpensive to produce.

### SUMMARY OF THE INVENTION

The present invention provides a child safety warning device that will alert a driver of the presence of a child within the vehicle after the driver has turned off the vehicle ignition. The child safety warning device is compact and can be easily transported between vehicles. Further, the simple design of the child safety warning device enables the device to be produced at a relatively low cost when compared with other child safety warning devices.

In a preferred embodiment, the child safety warning device includes a portable housing, a recording device located within the housing, a connector coupled to the housing and adapted to fit within a vehicle socket, and a switching device coupled to the recording device and the connector. The switching device provides a signal to the recording device indicative of an ignition state of a vehicle. The recording device plays back a prerecorded message in response to the signal provided by the switching device to warn the vehicle driver of the presence of a child within the vehicle when the ignition is turned off.

In a preferred illustrated embodiment, the switching device is a normally closed relay that is connected to the terminals of the connector. When the child safety warning device is inserted into a vehicle socket (for example a cigarette lighter socket or an auxiliary power socket) and the ignition is activated, the normal closed contacts open sending a signal to the recording device. The recording device plays a prerecorded message back in response to the signal received from the relay confirming to the driver that the child safety warning device is operational. Similarly, the contacts of the relay are closed when the ignition is turned off sending another signal to the recording device, thereby causing the recording device to play the prerecorded message back to remind the driver of the presence of a child within the vehicle.

Other features and advantages of the child safety warning device will become apparent from the following detailed description of the preferred embodiments of the invention.

### BRIEF DESCRIPTION OF THE DRAWINGS

Embodiments of the present invention will be described, by way of example, with reference to the accompanying drawings, wherein:

FIG. 1 is a perspective view of a child safety warning device in accordance with the invention; and

FIG. 2 is a schematic diagram illustrating the operational components of the child safety warning device illustrated in FIG. 1.

### DETAILED DESCRIPTION OF THE PREFERRED EMBODIMENTS

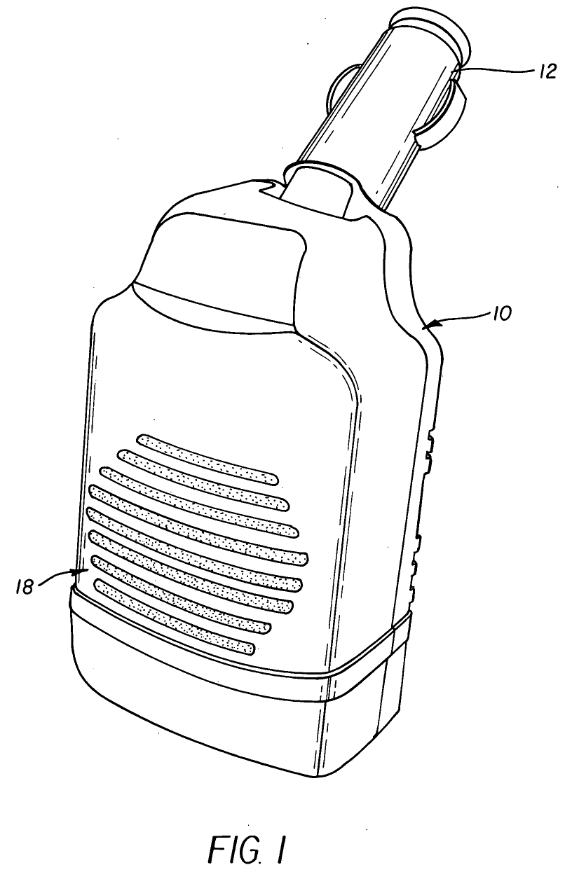

FIG. 1 illustrates a child safety warning device in accordance with a preferred embodiment of the invention. As shown in FIG. 1, the child safety warning device includes a housing 10 and a male connector 12 adapted to fit into a standard vehicle socket, for example, a cigarette lighter socket or an auxiliary power socket. The portable and compact design of the child safety warning device permits the device to be readily transported between different vehicles.

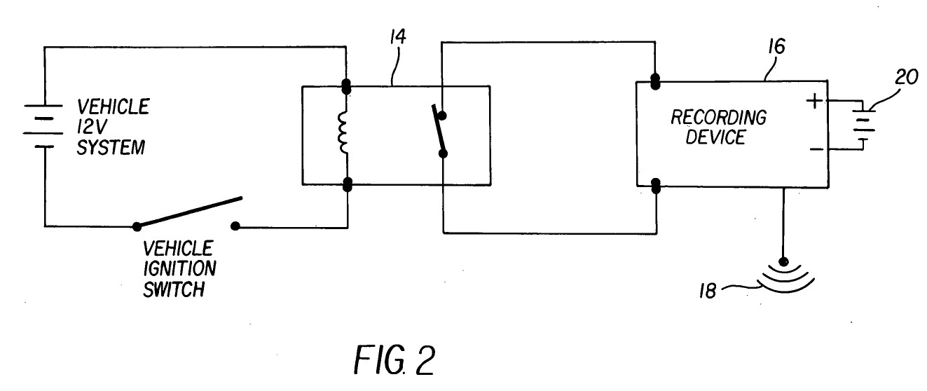

A schematic diagram of the operational components of the child safety warning device is illustrated in FIG. 2. A relay 14 (for example Siemens K10P-11D15-12) is connected to the terminals of the connector 12, such that when the child safety warning device is inserted into a vehicle socket, the control inputs of the relay 14 are coupled to the electrical system of the vehicle. In the illustrated example, the contacts of the relay 14 are coupled to input terminals of a recording device 16 (for example Radio Shack 276-1323). A change in state at the input terminals of the recording device 16 causes the activation of the recording device 16 and the playback of a prerecorded message over the speaker 18. The recording device 16 is powered by a battery 20 provided within the housing 10.

In operation, a driver inserts the child safety warning device into the vehicle socket. Upon activation of the vehicle ignition, the contacts of relay 14 open sending a signal to the recording device 16 that activates the playback of a prerecorded message. The prerecorded message is played over the speaker 12 verifying to the driver that the child safety warning device is operational. The driver then proceeds to drive to a desired destination. Once the desired destination has been reached, the driver proceeds with turning off the vehicle ignition. Turning the vehicle ignition off caused the contacts of the relay 14 to close sending a further signal to the recording device 16, thereby causing the recording device to play back the prerecorded message.

In the preferred embodiment, the prerecorded message states “Baby On Board” to remind the driver that a child is in the vehicle and needs to be removed from the vehicle. The same message can also be used when the device is first inserted into the socket. Although a more sophisticated circuit arrangement could be provided to utilize one message upon initialization and a second warning message when the ignition is turned off.

Modifications and variations are possible within the scope of the appended claims. For example, as will be readily appreciated by those skilled in the art, not all vehicles employ an electrical system in which power is turned off to the vehicle socket when the ignition is turned off. Instead, power is constantly maintained to the sockets regardless of the state of the ignition switch. In such situations, the connector must be adapted to connect to a portion of the vehicle's electrical system that will cycle with the state of the vehicle ignition. If desired, a male connector of the type illustrated may be employed in combination with a second connector used in those cases in which power is constantly maintained to the sockets. The second connector would be adapted to connect to a portion of the vehicle's electrical system that cycles with the operation of the vehicle ignition. For example, a connector could be utilized that can be inserted into the vehicle's fuse box. Still further, it will be appreciated that other switching devices or mechanisms may be employed to detect the change in state in the ignition and to supply a signal to the recording device.

1. A child safety warning device comprising:
a portable housing;
a recording device located within the housing;
a connector coupled to the housing and adapted to fit within a vehicle socket; and
a switching device coupled to the recording device and the connector;
wherein the switching device provides a signal to the recording device indicative of an ignition state of a vehicle; and
wherein the recording device plays back a prerecorded message in response to the signal provided by the switching device.

2. A child safety warning device as claimed in claim 1, further comprising a speaker coupled to the recording device.

3. A child safety warning device as claimed in claim 1, wherein the switching device comprises a relay.

4. A child safety warning device as claimed in claim 3, wherein the relay is a normally closed relay.
